(19) United States
(12) Patent Application Publication
(10) Pub. No.: US 2006/0179432 A1
(43) Pub. Date: Aug. 10, 2006

(54) System and method for controlling and monitoring an application in a network

(76) Inventors: Randall Walinga, Fonthill (CA); Rodney Peterson, Calgary (CA); Sean Walinga, Airdrie (CA)

Correspondence Address: MCCARTHY TETRAULT LLP, BOX 48, SUITE 4700,, 66WELLINGTON STREET WEST, TORONTO, ON, M5K 1E6, CA

(21) Appl. No.: 11/272,093

(22) Filed: Nov. 14, 2005

(30) Foreign Application Priority Data
Feb. 4, 2005 (CA) 2,496,231

(51) Int. Cl. G06F 9/44; G06F 9/445

(52) U.S. Cl. 717/171; 717/120; 717/176

(57) ABSTRACT

In the invention, a system and method for controlling applications at remote locations from a central server is provided. The system comprises an application agent at one remote location and a control system at the central server. The application agent controls each application installed thereat. There is also configuration data accessible by the application agent and the control system. The application agent periodically accesses the configuration data to determine operating parameters for each application; initiates activation of each application according to the configuration data; receives output data from each application; and produces a filtered version of the output data and forwards the filtered version to the server application. The control system receives, reads and stores the filtered data in an output file; and updates the configuration data to refine operation of said each application after analyzing the filtered data.

### FIELD OF THE INVENTION

The present invention relates to a system and method for remotely controlling and monitoring applications operating on elements in a computer network, in particular controlling multiple different applications installed on elements in the network.

### BACKGROUND

A computer connected to a network typically has several separate applications installed thereon. Some applications, such as user authentication and public key management applications, have centralized administration features, allowing them to be monitored and managed from a central location in the network. However, these applications cannot communicate with other different applications on the computer or in the network. Other applications do not have centralized administration features and operate separately and independently of the other applications installed on the computer.

As an example, a computer may have several security applications installed on it monitoring for intrusions, access requests and potential sabotage from unauthorized entities connected to the network. The applications may include intrusion detection services (IDS), virtual private network (VPN) services, firewall services and unauthorized device detection services. To have an effective suite of applications, each application needs to be monitored and controlled. Typically, applications are controlled by providing command line instructions to the operating system associated with the computer. It will be appreciated that this task becomes complicated as the number of applications grows large.

There is a need for system and method of centrally controlling and monitoring applications on a computer connected to a network from a remote location which addresses the disadvantages of the prior art.

### SUMMARY

In a first aspect, a system for controlling applications at remote locations from a central server is provided. The system comprises an application agent at one remote location and a control system at the central server. The application agent controls each application installed thereat. There is also configuration data accessible by the application agent and the control system. The application agent periodically accesses the configuration data to determine operating parameters for each application; initiates activation of each application according to the configuration data; receives output data from each application; and produces a filtered version of the output data and forwards the filtered version to the server application. The control system receives, reads and stores the filtered data; and updates the configuration data to refine operation of said each application after analyzing the filtered data.

In the system, the configuration data may be stored in a configuration file associated with the control system.

In the system, there may also be local configuration data for each application stored at the remote location containing initialization data for each application.

In the system, the control system may update the configuration data utilizing configuration data for another application.

In the system the control system may further provide an interface for an administrator to program update parameters for the configuration data based on the data of another application.

In the system, the local configuration data may be periodically compared and reconciled with the configuration data associated with the control system.

In the system, the application agent may further comprise a spawning module to control system calls for the application.

In the system the application agent may further comprise a generic control module controlled by the spawning module to execute commands having parameters which are stored with configuration data associated with the control system.

In the system, each application may relate to a security feature for the client.

In the system, the control system may utilize a set of conditions and a set of relationships linking elements in the set of conditions to trigger updating configuration data to refine operation of the remote application. Data for both sets may be entered by a system administrator.

In the system the control system may further comprise a reaction module to process data relating to the sets to selectively update the configuration data to refine operation of the remote application.

In a second aspect, a method for controlling applications monitoring activities at remote locations from a central server is provided. The method comprises controlling each application installed a remote location through an application agent; providing configuration data associated with each application at a central location; and providing a control system to manage updates to the configuration data in response to data provided from the application agent. Therein, the application agent periodically accesses the configuration data to determine operating parameters for each application; initiates activation of each application according to the configuration data; receives output data from each application; produces a filtered version of the output data; and forwards the filtered version to the server application. Also, the control system receives, reads and stores the filtered data in an output file; and updates the configuration data to refine operation of said each application after analyzing the filtered data.

In the method, the configuration data may be stored in a configuration file associated with the control system.

In the method, local configuration data for each application may be stored at the remote location containing initialization data for each application.

In the method, the control system may update the configuration data utilizing configuration data for another application.

In the method, the control system may further provide an interface for an administrator to program update parameters for the configuration data based on the data of another application.

In the method, the local configuration data may be periodically compared and reconciled with the configuration data associated with the control system.

In the method, the application agent may further comprise a spawning module to control system calls for the application.

In the method, the application agent may further comprise a generic control module controlled by the spawning module to execute commands having parameters which are stored with configuration data associated with the control system.

In the method, the control system may utilize a set of conditions and a set of relationships linking elements in the set of conditions to trigger updating configuration data to refine operation of the remote application. Data for both sets may be entered by a system administrator.

In other aspects various combinations of sets and subsets of the above aspects are provided.

### BRIEF DESCRIPTION OF DRAWINGS

An embodiment of the invention will now be described by way of example only with reference to the accompanying drawings in which:

FIG. 1 is a schematic representation of a network system wherein a client and an application management (AM) server relating to an embodiment are provided;

FIG. 2 is a block diagram of the client shown in FIG. 1;

FIG. 3A is a block diagram of the AM server shown in FIG. 1;

FIG. 3B is a screen shot produced by a builder module of the AM server shown in FIG. 3A;

FIG. 4 is a flow diagram of an application agent operating relating to an embodiment on the client shown in FIG. 1;

FIG. 5 is a flow diagram of a server application operating on the AM server relating to an embodiment shown in FIG. 1;

FIG. 6 is a flow diagram of a GUI application operating on the AM server relating to an embodiment shown in FIG. 1;

FIG. 7 is a block diagram of an architecture of the database used by the AM server; and

FIG. 8 is another block diagram of aspects of the client and the AM server of FIG. 1.

### DESCRIPTION OF EMBODIMENTS

The description which follows, and the embodiments described therein, are provided by way of illustration of an example, or examples, of particular embodiments of the principles of the present invention. These examples are provided for the purposes of explanation, and not limitation, of those principles and of the invention. In the description, which follows, like parts are marked throughout the specification and the drawings with the same respective reference numerals.

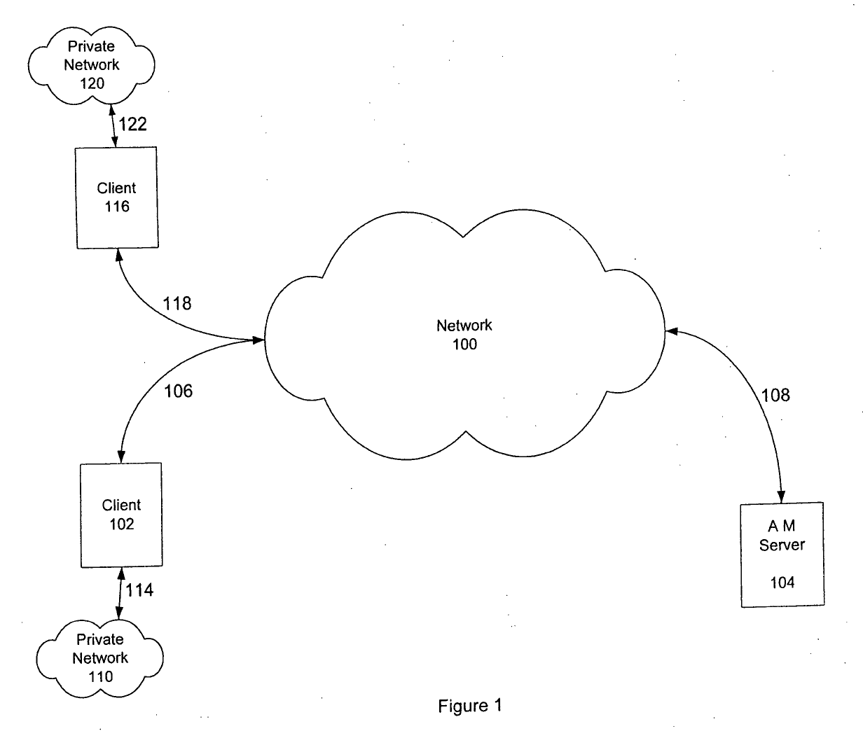

Referring to FIG. 1, an embodiment provides a system and method for controlling and monitoring a set of applications installed on a client computer connected to remote location via a network. Therein, network 100 is comprised of a series of interconnected communication devices, computers, routers, repeaters and other devices to allow elements connected to network 100 to communicate with other elements in the network. As such, network 100 may be implemented as a corporate LAN or WAN, any number or interconnected LANs or WANs, or it could be the Internet.

As shown, client 102 and AM server 104 are connected to network 100. Client 102 may be a computer, a communication device or a linking device to another network. Client 102 is connected through a communication link 106 to network 100, thereby establishing a communication link with any other element connected to network 100. Similarly, AM server 104 is connected through communication link 108 to network 100. Private network 110 is connected to network 100 through communication link 114 to client 102. Private network 110 may be comprised of one or more interconnected elements therein. Another client 116 is connected to network 100 through communication link 118. Private network 120 connects to network 100 through communication link 122, which is connected to client 116. Network 100 may use any known network protocol to control communication amongst its elements, including TCP/IP, IPX and other protocols known in the art. Further, network 100 may be configured as a LAN, WAN or any other network architecture.

As noted earlier, an application can be located on any element in network 100 (for example on client 102, in any intermediate element in network 100 or in server 104). Each application may be installed on one or more elements within network 100. Also, one or more different applications may be installed on a particular element in network 100. When two or more different applications are installed on an element (such as client 102), the applications provide a suite of services for that element. To initiate and control an application, commands and associated parameters may be entered by a user through a command line interface of the operating system installed on the element or through another interface, such as one provided by a developer of the application. However, to streamline control and monitoring of the application, the embodiment provides an application agent installed on the element to automate such tasks for that application and other applications installed on the element. Each application agent is responsible for sending relevant data relating to its local applications to AM server 104 for further processing. The data may relate to output generated by the applications or status changes for the applications. Typically, the data is sent as soon as possible; however, the data may be sent in batches. A central database associated with AM server 104 is used to store configuration data for several applications and several clients. As such, the AM server has network-wide data relating to applications and clients. The embodiment utilizes this data to allow specific customization and configuration updates for an application on a client based on information relating to other applications or other clients.

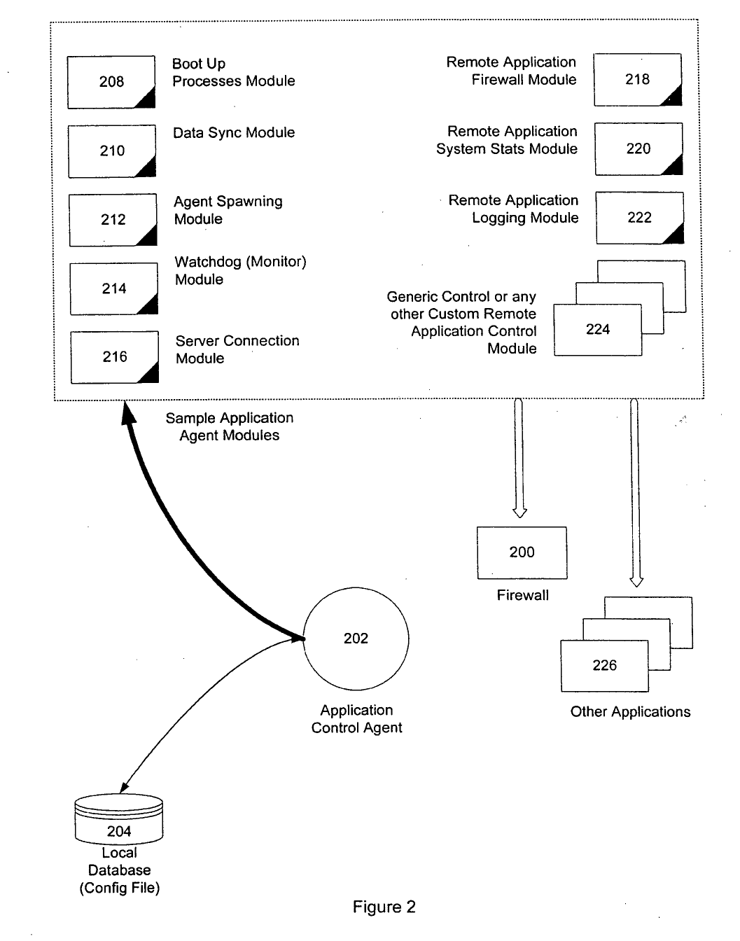

Referring to FIG. 2, further detail is provided on aspects of client 102 and its components. In particular, firewall 200, application agent 202, local configuration file 204 and other applications 206 are provided on client 102.

As is known in the art, firewall 200 is embodied in software and operates on client 102 to scan and filter incoming data, access and message traffic from network 100 and analyze their content to determine whether to forward them to client 102 and network 110. A firewall is often installed at an access point away from the rest of elements in network in order to prevent an incoming request from directly accessing the elements in the network.

It will be appreciated that any type of application 206 can be installed on client 102 and controlled by application agent 202. One type of application relates to monitoring functions. Exemplary monitoring functions include intrusion detection services (IDS), virtual private network (VPN) services, firewall services, unauthorized device detection services on adjacent networks, promiscuous mode detection from adjacent networks, traffic throughput optimization and network traffic congestion and error rate analysis. A monitoring application may monitor for: an appearance of an unauthorized service (e.g. an unauthorized FTP or WWW server) in network 100, 110 or 120; a hacker entering into a corporate web server; disk space usage of its associated element. For each monitored condition, the embodiment may be configured to notify an appropriate administrator, block the access attempt, place the identity of the intruder on a blacklist, or archive the data on the associated client. In another example application agent may control a Windows Server (trade-mark of Microsoft Corporation) installed on the client. From the client, the agent application reads a central database for configuration instructions and then runs a Windows Server agent module that manipulates the Windows registry on the client in order to effect the parameters required by as per instructions provided in the central database. Other applications include measuring and counting applications. For example, an application may measure ambient conditions (e.g. temperature, pressure) around the element on which it is installed or an application which counts identifiable items being processed by its associated element. In yet another example, an application may be installed on a client which is controlling a step in a manufacturing process, e.g. the speed of a conveyor belt.

An application may be implemented using publicly available software, including software licensed under GNU GPL. For example, for a monitoring type of application, a VPN may utilize IPSEC and Openswan as provided in the Fedora Linux operating system from Red Hat, Inc.; a firewall may utilize the IPTables provided in the Linux operating system kernel; an IDS may be provided through Snort, which is available through an open source general public license (GPL). Traffic prioritization may use the Shapecfg routine provided in the Linux operating system kernel. Alternatively, an application may be obtained from commercially available sources or may be programmed by a user.

Further detail is now provided on operation of application agent 202. Application agent 202 controls all applications on its associated client and is comprised of the following modules: initialization module 208, data synchronization module 210, spawning module 212, monitor module 214, service connection module 216, remote application firewall module 218, remote application system status module 220, remote logging module 222, generic control module 224 and other applications 226. Briefly, the modules collectively and individually: (i) selectively control and to configure each application installed on the client; (ii) read output from each application; and (iii) communicate with AM server 104. The application agent also provides data integrity and data synchronization with its local database 204 to the main database (required typically for boot up and initial connection parameters to the AM server). Since applications on clients in network 100 typically operate independently of each other, data synchronization is useful to synchronize an application's local configuration data with any centrally stored configuration data when a network is lost or the network goes down.

As such, application agent 202 controls the operation of firewall 200. For example, the level of screening conducted by firewall 200 may be configured by application agent 202. One level of screening examines the incoming traffic to see whether it originates from an acceptable domain name or IP address. For example, an acceptable source for traffic may be a previously identified IP address. Another level of screening examines emails for any encrypted attachment. Also, the action taken when traffic is identified as being problematic may be configured. For the emails having encrypted attachments, the attachment may be removed or the email may not be forwarded to its intended recipient.

As noted above, an application may be controlled by providing commands and parameters to an operating system command line interface on client 102. In order to implement this control, the application agent can generate and submit to the operating system a set of commands and parameters in lieu of manually entered commands.

Further detail is now provided on the issue of data and control management of an application. As there are several commands and parameters available for the application, the embodiment stores data relating to the commands and parameters in configuration files. Content of the configuration files is controlled by AM server 104. As will be described later in detail, the configuration files include a master control table which provides a facility for controlling operation of applications by having sections of the table reserved for specific applications and by having predefined specific fields in the sections contain configurable data or commands which are accessed and then used to implement a command relating to that application. The master control table may have a link to one or more custom control tables. Additional data files may also be present as part of the configuration files. The application agent periodically accesses its section of the master control table to identify whether any commands are to be initiated for it. While some applications may not need to have a section in the master control table, in many cases, in order for application to operate correctly and be controlled centrally by the AM server, it is necessary for it to have entries in the master control table.

For example, if a VPN is being established using the Ipsec and OpenSwan applications, they require at least three configuration files in the embodiment in it's most basic configuration, two global files and one for each VPN definition. In this case the application agent 202 spawns a VPN module (not shown) which reads the parameters stored on the server tables (or local tables if synchronized) and creates the required configuration files for the applications. The VPN module then sets a status field in a VPN definitions table to indicate that it has completed its reconfigurations, but has not yet started the VPN. It will wait until the other end of the VPN has been configured as well. Once each side of the VPN has set its flag in its status field to indicate that it is ready, then the VPN modules (on both sides) start the VPN and set the flag in the status fields to “started”.

Application agent 202 periodically accesses the configuration file at the AM server to determine whether there are any configuration adjustments for its associated application(s). For example, for a network scanning application, the frequency and range of segment scanned may be configured. Once the associated configuration file is updated with the appropriate updates, the application agent can access the configuration file and launch (i.e. spawns) the application with the appropriate parameters. Once results of a scan are provided by the application, the application agent receives the data, filters, parses and formats it, then forwards the formatted data to the AM server.

An application also produces output, such as statistics and reports. For firewall 200, the reports can include data relating to unauthorized access requests, such as the network addresses of the unauthorized requestor and the time of the request. In order to centralize the storage and processing of the output of an application, the corresponding application agent processes the output and forwards the output to the AM server for further processing.

Further detail is now provided on the modules of application agent 202. On start-up of client 102 and application agent 202, no application is running and application agent 202 has not established communications with AM server. Initialization module 208 generates and sends necessary operating system commands to the operating system of client 102 to initialize a communication session between the application agent 202 and the AM server and to initialize any applications which require initialization prior establishment of the session. As AM server has configuration data for the applications installed on client 102, if an application requires initialization prior to establishment of the communication session between AM server and the application agent, then local initialization data associated with the application is accessed by the initialization module to enable it to provide a proper initialization command and parameters to the operating system.

Data synchronization module 210 synchronizes any tables that are flagged to be synchronized by configuration files. This includes data used for initialization. In operation, data synchronization operates as follows. First, when the AM server updates a configuration file for an application it sets a status flag in the relevant section of the master control table for the application. This flag can indicate the existence of a “new record”, “changed record”, “deleted record”, or “record is current”. If the synchronization module detects a “new record” status in the master control table for its application, then it inserts the new record into the local control table of the local configuration file stored at the client and changes the status in the master control table to “record is current”. If the status is “changed record” then the synchronization module updates the record in the local control tables on the client and then sets the related status in the master control table to “record is current”. If the synchronization module sees “deleted record”, it deletes the record from the local control table and sets the related status in the master control table to “null”. “Null” is a special case signifying to the AM server that the “record delete” operation has been completed at the remote location and as such the master record may also be deleted. If the synchronization module sees “record is current” in the relevant record in the master control table then it does nothing to the record in the local control table or the master control table. In another embodiment, the synchronization module can perform a hash function on the local and central configuration files and compare the results. If the hash values do not match then there is a discrepancy and the master control table is assumed to be correct. As such, the synchronization module sets the status in the relevant record in the master control table to “changed record”. Thereafter, the synchronization module would thereby subsequently notice the “changed record” status for the configuration file, then it would update the local configuration file records and finally set the status of the relevant record in the master control table back to “current record”.

Spawning module 212 is responsible for selectively generating activation commands for specified applications and providing those commands to the operating system. When the operating system processes the associated spawn command for an application, the application is started. Applications may be activated at specified times with specified parameters. The activation parameters are stored in the control tables updated by AM server. Spawning module periodically accesses the control tables for application activation data. When the spawning module determines from an application's activation data that the application should be started, the spawning module generates an operating system level activation command on client 102 with specific operating parameters specified in the table.

Monitor module 214 monitors the status of applications that have been spawned by spawning module 212. The operation condition of an application may be marked to be “critical”, “always running”, “run once”, “run at specified times” or others conditions as required. The type of application spawned will determine how an operating condition of an application is checked. Custom designed modules can have a direct thread from the spawning application. Other modules will check the status of the process ID assigned to the application by the operating system of the client. Other modules may issue a status request command relating to the application to the operating system and then monitor the responses from the operating system for specific information indicating the status of the application. Once it has a report of the currently operating applications, monitor module 214 checks the operating conditions of the applications. If an application is not operating which should be operating, it sends a signal to spawning module 212 to re-spawn it. Alternatively, it may re-spawn the application itself. It also generates and sends status and error messages to the database of the AM server. In the present example, firewall application 200 should always be running. Monitor module 214 periodically tests the status of the firewall, then updates the application status flag on the AM server master control table, if required and sends reports to the AM server on the status.

Server connection module 216 defines and controls how the agent application accesses the central server database. In the exemplary embodiment, module 216 communicates through an SQL connection socket that is tunnelled through a point-to-point encrypted VPN. The module also encrypts and decrypts data fields as required and provides data security and data integrity over the communication link. Any encryption keys for module 216 are stored locally in data structure 204 in an encrypted format.

Remote application firewall module 218 parses relevant fields in the server or local configuration data structures and then start the firewall accordingly. This module also monitors output and errors accordingly, and send the results back to the server database structure. This module may be activated by spawning module 212 or by the monitoring module 216.

Generic spawning module 224 spawns generic applications that can be controlled and defined by generic configuration parameters. It is written in java. In other embodiments, other programming languages may be used. The generic spawning module 224 will run or execute any operating system command or command-line computer application that it is given and parse the results as instructed. Its most frequent use is when an application to be run is too complex in how it needs to be controlled or how the output needs to be parsed, such that a static commands are too cumbersome.

In operation, generic application module 224 is started by spawning module 212 there is a special entry in the master control table of the configuration file. Parameters pertaining to the generic application to be executed by the generic application module are provided in a MOD_PARAMS field in the master control table. As such, spawning module 212 controls when and how often the generic application module 224 is executed. Once the generic application module 224 is activated, it controls operation of the specified application utilizing the parameters that have been passed to it. This is accomplished with known programming techniques based on the language used. As noted, the generic application module is written in java. As such, java runtime procedures are used by the generic application module to spawn the generic application passed to it. Furthermore the generic application module can trap output from the command per instructions received from the spawning module and subsequently by entries in a MOD_RETURN field in the master control table. For example if the MOD_RETURN field value was “1” (meaning to trap and log the output) then the generic application module will start an inputstream buffer and directs the output from the spawned application to the inputstreambuffer. The buffer subsequently will write its contents to the system logger. This may be implemented by either writing directly to a predetermined logging pipe or by using a system logger routine.

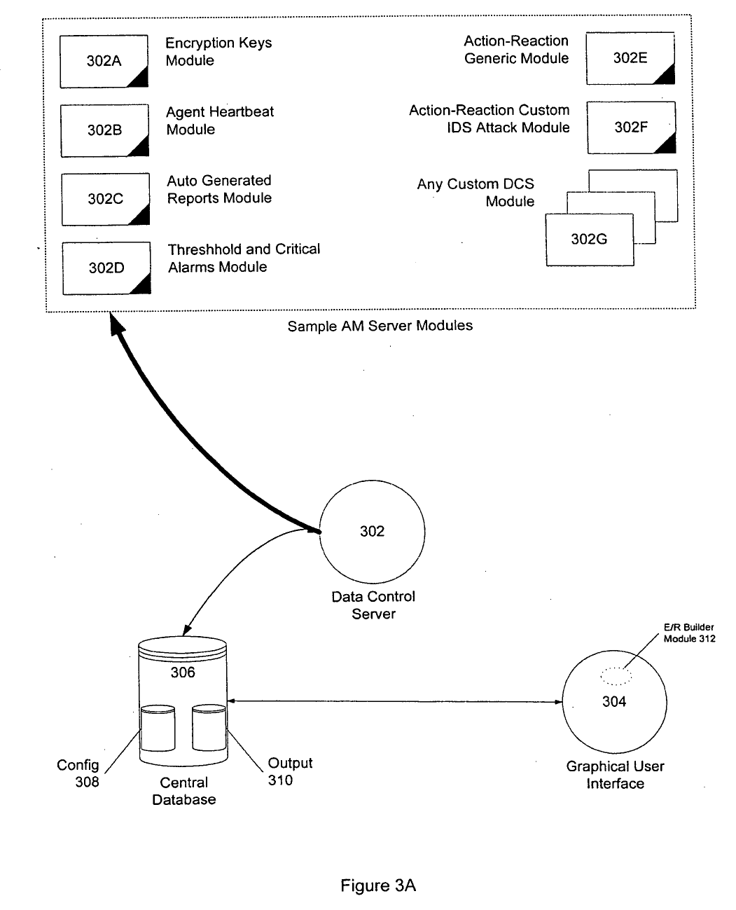

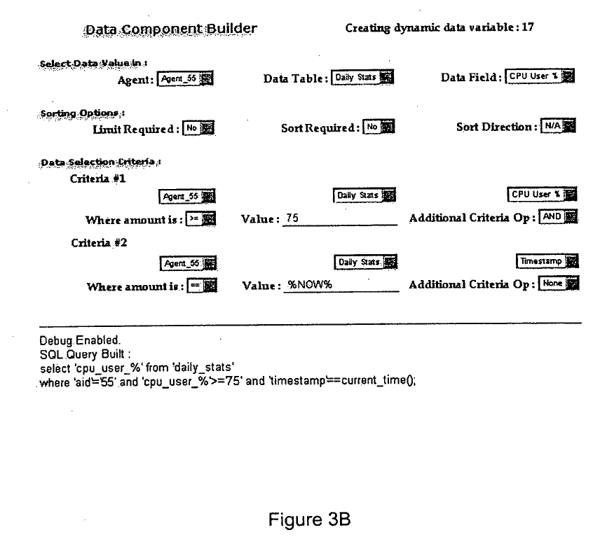

Referring to FIG. 3A, further detail is provided on AM server 104. Ultimately, through control of the application agents, AM server 104 controls all of the connected applications installed throughout network 100. Through the central database 306, the AM server creates control entries in control tables which are read and reacted to by the application agent(s). In the embodiment, the database is an SQL database. However, in other embodiments, other type of files (e.g. binary files) may be used to store configuration information regarding an application. Control system software is installed on AM server 104 to provide functional aspects of AM server 104. The control system controls a suite of software routines which communicates with the application agents installed on elements in network 100 in order to monitor and control operation of the applications installed on those elements.

As AM server 104 has access to all configuration files for all applications, it can provide a suite of commands to an application agent to individually control one or more installed applications in a predefined routine. In the security application example, this arrangement enables a sophisticated and multi-pronged security approach using multiple applications installed on a client. For example, consider a client having a network scanner application, a promiscuous monitor application and a firewall installed thereon with an associated application agent. By making appropriate settings in the configuration files, AM server 104 can cause the application agent to activate the network scanner application to scan a network defined by a certain range for any new devices or services, and then activate the promiscuous monitor application to scan everything on its segment for promiscuous devices. Results of the scans are received by the application agent, which then parses the data and sends it to AM server 104. Any newly identified problematic devices identified in the data are identified by AM server 104 and it updates the configuration files for the firewall associated with the application agent to cause the firewall to block the IP address of the problematic devices. If a system administrator clears the problematic devices, then AM server 104 updates the configuration files to unflag the blocking of the problematic devices.

Further detail is now provided on a master control table of the configuration files accessed and managed by AM server 104. As noted, the master control table is a data structure which has predefined fields for each application. The data in the fields are accessed by an application agent to determine how to control and configure operation of applications operating on a client. The data structure of the configuration files may be a table, a text list, a binary string or any other appropriate structure. For example, for a firewall application, one field may define a set of acceptable IP addresses. Another field may contain a code indicating an action to take by the firewall application if a particular class of traffic is received. For example a code may signify that if traffic from a specific source is received, then the traffic is automatically rejected. In use, the application agent periodically (e.g. every 5, 10, 15 or 60 minutes) reads the file to determine the current configuration intended for the application. Once application agent 202 determines the configuration, it will send an instruction to the application to change its reporting or filtering process, as required. Also, any data produced by the application is received by the application agent 202 and is formatted and forwarded for storage in the output file. In the embodiment, Table 1 defines fields for a master control table located in the database of AM server 104:

TABLE 1

| Field | Comments |
|---|---|
| AID | Application agent identifier. |
| ENABLED | Boolean value indicating if this application is currently |
| | enabled or disabled. |
| LD_SYNC | Boolean value indicating if local data sync is required. |
| MOD_NAME | Text name of the remote application (i.e. “Firewall”). |
| MODULE | The Java module that the application agent is to |
| | spawn. |
| MOD_TYPE | 0 = run once |
| | 1 = run periodically |
| | 2 = run at specified times |
| | 3 = always running. |
| MOD_PARAMS | contains any parameters that need to be passed by the |
| | application agent to the application spawning module. |
| | If it is the generic application module, then these get |
| | passed to the application being controlled. |
| MOD_TABLES | a list of tables (space separated) to be synchronized |
| | locally. |
| MOD_RETURN | 0 = no return considerations. |
| | 1 = std out, catch and send to local log. |
| | 2 = std out, catch and send to central db. |
| | 3 = output directly to log. |
| MOD_STATUS | 0 = not yet started. |
| | 1 = started and running. |
| | 2 = ran and finished okay. |
| | 3 = is not running but should be. |
| | 4 = ran with error. |
| MOD_FREQ | If MOD_TYPE = 1, then this is the interval in |
| | minutes to spawn the application. For example if |
| | this is 45, then the application will run every |
| | 45 minutes. |
| | If MOD_TYPE = 2, then this is a space separated list |
| | of specific times in the day to run the application. |

Amendments may be made to Table 1 to enhance functionality. For example, a MOD_FREQ_TYPE field may be added to indicate a presence of a day of the week or a day of the month in the MOD_FREQ field to enable use of weekly or monthly schedules. Also other execution methods and data return types may be provided in the MOD_TYPE and MOD_RETURN fields. Several examples of filled master control tables are provided below.

As an example, Table 2 contains data of an exemplary snapshot of a control table where a custom application in java has been provided for a client (identified as application agent #2) in network 100 and a specific command relating to a data logger application is provided.

TABLE 2

| Field | Setting | Comment |
|---|---|---|
| AID | 2 | Application Agent #2 |
| ENABLED | true | Data logger is enabled to |
| | | run |
| LD_SYNC | false | No synchronization of |
| | | local initialization data (if |
| | | any) is required |
| MOD_NAME | System Log Parser | Text name of module |
| MODULE | LoggerD | java module to spawn |
| MOD_TYPE | 3 | it is always running |
| MOD_PARAMS | “ ” | no parameters are provided |
| | | on instantiation |
| MOD_TABLES | “ ” | No tables are to be |
| | | synchronized |
| MOD_RETURN | 0 | No output |
| MOD_STATUS | 1 | started and running |
| MOD_FREQ | “ ” | not applicable |

In Table 3, the command table contains parameters indicating that for application agent 105, the generic application module is activated. Generic application module operates by executing commands with parameters that are identified is tables. The values in the tables are set by the administrator. They may also be triggered by another event. As noted, for the sake of centralizing data, these values and tables are stored at AM server 104 in a master control table.

For the MODULE field in Table 3, the setting is “generic”. When this data is picked up by the spawning module, it executes the generic application module. The parameters for the generic application module are provided in the other fields in the Table, notably the “MOD_PARAMS” field. Therein the “df-h|mail-S ‘Disk Space admin@company.com” command is provided which is a UNIX command to check the disk space of the client associated with application agent 105, followed by a command to send an email a message containing the disk space used to an administrator. The spawning module also obtains the timing data from the table. Here, the generic application module is run with the commands and parameters provided at midnight each day. The output from the command is caught by the generic application module, which then format and filters the output data and sends it to AM server 104 for updating the relevant information in the central database.

TABLE 3

| Field | Setting | Comment |
|---|---|---|
| AID | 105 | Application Agent |
| | | #105 |
| ENABLED | true | application is enabled |
| LD_SYNC | false | no local sync required |
| MOD_NAME | Email disk size | |
| MODULE | generic | name of java module |
| | | to spawn |
| MOD_TYPE | 2 | run at specified times |
| | | per MOD_FREQ |
| MOD_PARAMS | df - h \| mail -s ‘Disk Space’ | parameter list |
| | admin@company.com | executed with the |
| | | module; the ‘generic’ |
| | | module runs this field |
| | | as an OS command |
| MOD_TABLES | “ ” | No synchronization |
| | | required |
| MOD_RETURN | “ ” | No return |
| | | considerations |
| MOD_STATUS | 1 | module is started and |
| | | running |
| MOD_FREQ | 00:00 | run every day |
| | | beginning at midnight |

In Table 4, application agent 55 is to spawn the AgentBoot module when it starts up. It is also supposed to keep the central data tables ‘net_config’ and ‘net_dev’ synchronized with a local version. The output is to be caught and sent to the system logs. This module will not actually be spawned because the enabled flag is set to false, although synchronization will still take place. Initialization module 208 is used to configure network interfaces.

TABLE 4

| Field | Value | Comment |
|---|---|---|
| AID | 55 | Agent application #55 |
| ENABLED | false | Currently not enabled |
| LD_SYNC | true | To sync local and central |
| | | files |
| MOD_NAME | Network Boot Up | |
| MODULE | AgentBoot | java module to spawn |
| MOD_TYPE | 0 | Run once |
| MOD_PARAMS | “ ” | no parameters |
| MOD_TABLES | net_config net_dev | These two tables must be |
| | | synchronized with their |
| | | respective local tables at |
| | | the client associated with |
| | | agent application #55 |
| MOD_RETURN | 1 | Standard output, sent to |
| | | local log only |
| MOD_STATUS | 0 | Not yet started |
| MOD_FREQ | “ ” | not applicable |

Referring to FIG. 3A, further detail is provided on the components of AM server 104. Therein, control system 300 provides a single, unified interface for configuration, controlling, and analyzing data from applications operating on clients 104 in network 100. In the embodiment, control system 300 provides a web-based interface to manage functions for each recognized application. The system gathers information from each application through its associated application agent and generates cohesive, comprehensive reports, providing data returned from one or more application agents to generate reports, critical alarms, or to otherwise act proactively in anticipation of an event. The three main modules in system 300 are server application 302, GUI application 304 and database 306. It will be appreciated that the modules may be installed on separate servers, with appropriate network connections amongst each module. Each module is described in turn.

Server application 302 provides instructions for the control and operation of the application agents and the related applications installed in the elements. It also manages a logic of responses to events and generates any automated reports and executes any other automated tasks.

GUI application 304 provides a user interface for a system administrator controlling operation of the control system. Routines in GUI application 304 allow the administrator to view status information of any agent in real-time (or as soon as the agent has sent that information), define reaction conditions based on data received from application agents and generate reports. The GUI application provides central management interfaces for AM server 104. In the embodiment, the GUI application is written in Java. GUI application 304 is implemented as a web-based front-end to enable clients to perform a number of on-demand tasks. If an administrator is paged that an event has happened, he can access the GUI to get much more detail on exactly what has happened and when. The administrator can initiate responses or alter configuration parameters within the GUI.

Database 306 contains configuration files 308 and output files 310. Database 306 contains remote application control information, any intelligence collected on an application, logging information for an application, output from an application and parameters for event-reaction modules (described later). For convenience, the configuration and output files are located on server 102, but in other embodiments, one or both may be stored at a remote location from server 102. In other embodiments, one file may contain both the output and configuration files. In other embodiments there may be multiple AM servers in lieu of one AM server. In other embodiments the database 306 and its input and/or output files may be located over many systems in a distributed storage configuration or they could exist identically on many systems in a clustered environment. In the embodiment, all data is entered and retrieved from database 306 through SQL commands. As such, AM server 104 generates and provides SQL compatible read and write commands to database 306. After the command is executed, database return either results for a query command or updates its records with the parameters of the write command.

Turning back to server application 302, further detail is provided on its components. Using data in database 306, for each application, server application 302 can generate reports, trigger alarms or make changes in reaction to recent events. Server application 302 has several modules which provide individual tasks which collectively perform (automated) tasks that involve database 306. Such modules include: encryption key module 302A, client heartbeat module 302B, report generation module 302C, alarm module 302D, Event-Reaction/Generic module 302E, Event-Reaction/IDS Attack module 302F and other modules 302G. Further detail is provided on selected modules.

Report module 302C is configured by parameters in the central tables for the applications. Values for the parameters are set by the administrator through GUI application 304. The reporting module generates three type of reports: graphical; text; and e-page.

A graphical report provides reports containing graphed data, such as trend-graphs and “top-10” charts. The graphs are created using known programming techniques and may be formatted into an html page and emailed to identified recipients. Exemplary charts and graphs relate to system statistics, such as: cpu usage %, load average, disk usage, network throughput, network errors, IDS alerts, FW accepted/rejected, etc. Additional reports may indicate: number of IDS attacks to an IP address grouped by 24 hour periods; a chart of most popular attack methods; and a grouping of all events over a defined time period to create a time-of-day graph of the CPU or traffic or IDS events. It will be appreciated that the reporting module can be customized to generate a report on any triggerable condition.

A text report comprises a text message which is sent to a predefined recipient. The message typically is a notification of an event. In one form, it is a text data dump of raw output data. Typically, the text data can be imported into a database program, such as Excel (trade-mark of Microsoft Corporation) and then further analyzed with other data. For example at the client, the CPU monitoring agent reports that the CPU has exceeded 90% utilization for more than 5 minutes. A text report is a raw text output of the data to be reported. In other embodiments, the trigger may be provided from an IDS alert, a listing of packets that a firewall allowed or rejected.

An e-page report is a brief email report generated when the corresponding certain alarm condition or threshold is met. It is useful for sending a short text message to a pager or a cell phone. For example, when an attack is detected, its particulars may be culled into the following e-page report sent to the pager of the system administrator:
Attack in Progress!
110 attempts on Teilhard from 10.1.1.5

Server application 302 also controls the content of the configuration files. In particular, it controls reconfiguration of a configuration file using output data received from the application agents. Server application 302 can read selected fields from the configuration files, and then can analyze the data against reaction parameters to determine whether further adjustments are required to the any configuration data to change the operating parameters of any applications. If so, the appropriate changes, per the reaction parameters are made to the appropriate configuration data files. For example, for intrusion detection, the output from the IDS is continually checked to determine whether an attack has occurred or is in progress. If any attack has occurred, the severity of the attack is analyzed. If the attack is recognized as being severe, then server application may be configured to send an alarm to the administrator. Next, to block the address of the attacker (e.g. IP A.B.C.D), server application may set configuration files of other applications to appropriately block matters relating to the network address (i.e. IP A.B.C.D) associated with the attacker. It will be appreciated that if several instances of an application are installed across several different clients in network 100, when one instance of the application detects a condition requiring an update to its configuration file, the server application can subsequently selectively update the remaining instances with the same update, or a modified version of the update. It will further be appreciated that any update information provided by an application may be used by other different applications controlled by the control system to alter their respective configuration files. It will further be appreciated that a timely response to an event can be important. In this example the attacker will be blocked within minutes. Conversely, prior art systems can require that a system administrator manually reconfigure a firewall application after an IDS report is received, thereby requiring human intervention and loss of time for blocking the intrusion attempt.

Event-Reaction/Generic (“E-R/G”) module 302E and Event-Reaction/IDS Attack (E-R/IA) module 302F are used to control the content of the configuration files. It will be appreciated that other event-reaction modules may be developed using concepts described here, amended as appropriate for the requirement at hand.

The E-R/IA module 302F analyses for IDS alerts. The E-R/I-A module 302F knows the content and structure of specific fields for the IDS and for the firewall that it will have to manipulate. Module 302F produces targeted queries to the database. For example, the following action statement can be sent by module 302F to check alerts of a certain priority level and then define a reaction to the level of alerts:

If <X> alerts of priority <Y> is exceeded in <Z> minutes from a single IP → block IP <yes/no>

Meanwhile, the E-R/G module 302E provides more flexibility with the structure of its commands. It enables AM server to change the configuration parameters of any of its controlled applications by changing the appropriate configuration files when certain specified conditions are detected by AM server 104. In order to provide this functionality, two programming elements need to be provided by the administrator to E-R/G module 302E via control tables. First, the administrator needs to define a set of conditions which must be present to cause a change in a configuration for an application. Second, elements in the set need to be linked together using a linking routine to define relationships amongst the elements, enabling the administrator to define a logical chain of events from the conditions. Each element is described in turn. To implement the first programming element, the administrator uses builder module 312 in GUI application 304 to define each condition. FIG. 3B shows a screen shot of builder module 312. As seen, the administrator can build a series of conditions which are to be checked. For the particular screen shown, the ‘CPU USER %’ value entered in at the current system time for client 55. The structure and programming logic needed to create builder module 312 and to implement any logic programmed therein are known to those skilled in the art.

Each condition is stored in database 308 in data_components. Table 5 shows records for data_components which are populated by builder module 312. Briefly, a set of conditions may have a sub-set of conditions defined therein. Each subset of conditions is tracked by a _X suffix, where X=0, 1, 2, 3, etc.:

TABLE 5

| Field Name | Description |
|---|---|
| ID | Data component index |
| NAME | User Friendly name of the data component (i.e. |
| | Instantaneous CPU Percentage) |
| S_TBL | The table name in the configuration file that contains |
| | information relating to the definition |
| S_FLD | The field name that contains information relating |
| | to the definition |
| LIMIT | Limit the results to one value true or false. |
| ORDER | If this is true then an “ORDER BY [S_FLD] |
| | DIRECTION” is applied to the SQL statement. |
| ORDER_DIR | Assigns the DIRECTION above to either |
| | ascending or descending. |
| W_FLD_0 | SQL “Where” clause field name for the first test. |
| W_VAL_0 | SQL “Where” clause first test value. |
| W_TYPE_0 | SQL “Where” clause test type (=, <, >, !=). |
| | Can be an integer representation (i.e. 1=“=”, 2=“>”, |
| | etc.) |
| W_OPAND_0 | SQL “Where” clause operation (and, or, none). |
| | Can be an integer representation. |
| W_FLD_1 | SQL “Where” clause field name for a |
| | second test associated with the definition |
| W_VAL_1 | SQL “Where” clause second test value for the |
| | second test. |
| W_TYPE_1 | SQL “Where” clause test type for the second test. |
| W_OPAND_1 | SQL “Where” clause operation for the second test |
| . . . | . . . |
| W_FLD_X | The following fields define further subset |
| W_VAL_X | conditions for the condition up to a maximum number |
| W_TYPE_X | of conditions you want to be able to use |
| W_OPAND_X | per data component. |

Based on the following entries for Table 5, the example provides a data definition where a first data component is the cpu % recorded most recently and a second data component is the cpu % recorded immediately before the recent recordation. Therein, the administrator defines a logical event to occur when the cpu % recorded most recently and the cpu % recorded previously for a client are both more than 75%. If both events occur, then the administrator wishes to reboot the client and send an alert to the AM system. As shown in Table 6, for that definition, the data component entries would be:

TABLE 6

| Field Name | Content | Description |
|---|---|---|
| ID | 1 | Data component index, this is the first one created. |
| NAME | CPU % Now | Text name of the data component. |
| S_TBL | daily_stat | The table to be queried in the database. |
| S_FLD | cpu_total | The field in the table to be queried. |
| LIMIT | n/a | No limit definition |
| ORDER | n/a | No order definition |
| ORDER_DIR | n/a | No order direction |
| W_FLD_0 | Aid | Select where ‘aid’ field |
| W_VAL_0 | 5 | Target value of ‘5’ |
| W_TYPE_0 | = | ‘aid’ = ‘5’ |
| W_OPAND_0 | And | ‘and’ the following . . . |
| W_FLD_1 | Minute | Select where ‘minute’ field |
| W_VAL_1 | date + % M % 5 * 5 | This variable returns the current minutes past the hour in 5 |
| | | minute increments 0, 5, 10, . . . |
| W_TYPE_1 | = | ‘minute’ = <closest 5 minute value> |
| W_OPAND_1 | and | ‘and’ the following . . . |
| W_FLD_2 | hour | Select where ‘hour’ field |
| W_VAL_2 | date % H | The current hour of the day. |
| W_TYPE_2 | = | ‘hour’ = <this hour> |
| W_OPAND_2 | | Not applicable, no more conditions to be applied. |
| . . . | | |

The above entries creates a logical data value which states:
Get me the CPU percentage recorded in this 5-minute interval for Agent 5. It is equivalent to the SQL query:
select cpu_total from daily_stat where aid = 5 and minute = <dynamic value> and hour = <dynamic value>
This data component is assigned its value whenever it is used at run-time. It is assigned the name DC[1] (data_component id #1)

Once the first programming element is defined, the administrator can then define relationships amongst the data components by populating a Generic Event-Reaction Definition Table, using builder module 312. Table 7 illustrates exemplary fields provided for the Generic Event-Reaction Definition Table:

TABLE 7

| Field Name | Description |
|---|---|
| EVENT_ID | Index |
| NAME | User-friendly name for the definition. |
| ENABLED | On or off |
| ACTION_S_CMD | Command to run on the server if events are true |
| ACTION_S_MODULE | Java module to spawn on the server if events |
| | are true |
| ACTION_AGENT | Central database values to manipulate if events |
| | are true. |
| DC_0 | Data component index of the first variable |
| TST_TYPE_0 | Comparison operator for the test. E.g. =, >, <, |
| | != Can be an integer representation or string. |
| TST_VAL_0 | The value to test the data component against. |
| OPAND_0 | The operation type to append this result to. e.g. |
| | AND, OR. |
| PRECEDENCE_0 | AND operation precedence is permitted which |
| | allows for parenthesis in the equation. |
| DC_1 | Data component index of the second variable |
| TST_TYPE_1 | Comparison operator for the test. E.g. =, >, <, |
| | != Can be an integer representation or string. |
| TST_VAL_1 | The value to test the data component against. |
| OPAND_1 | The operation type to append this result to. e.g. |
| | AND, OR. |
| PRECEDENCE_1 | AND operation precedence is permitted which |
| | allows for parenthesis in the equation. |
| . . . | . . . |
| DC_X | The number of iterations of data component |
| | variables you have here (i.e. DC_0, DC_1, |
| | DC_2, DC_3, . . . ) will determine the |
| | maximum number of data component variables |
| | provided in the logic statement. |
| TST_TYPE_X | |
| TST_VAL_X | |
| OPAND_X | |
| PRECEDENCE_X | |

It will be seen that in a Table 7 defines a set of conditions and parameters which need to be satisfied in order to execute ACTION_S_CMD.

Table 8 illustrates a logic chain for the following string:

when “data component 1”>75 AND “data component 2”>75, then send an email to the administrator (action_server_cmd) and reboot the client.

Rebooting the client may be accomplished by manipulating the master control table, then instructing that client to immediately spawn the generic application module with the mod_param set to “reboot” which instructs the OS on the target client to run the system reboot program. Alternatively if an application control entry already exists to reboot that particular client, then the system can simply set the enabled flag to true. If data component 1 (the CPU percentage example in Table 6) and data component 2 are both greater than 75, then the E-R/G module runs an operating system command to e-mail an alert message to the administrator. It also updates the master control table inserting the appropriate entry to reboot the remote client system. Manipulation of the control table to effect this entry has been described above in the discussion relating to manipulation of the master application control table to effect changes on a remote client application.

TABLE 8

| Field Name | Value | Description |
|---|---|---|
| EVENT_ID | 1 | |
| NAME | Reboot on High CPU | |
| ENABLED | True | |
| ACTION_S_CMD | “mail -s “Alert CPU Level High . . . Setting | |
| | Reboot Control” admin@company.com” | |
| ACTION_S_MODULE | | |
| ACTION_AGENT | update_control($dc0.w_val0, true, | |
| | true, “Reboot Agent”, “”, 0, “init | |
| | 6”, “”, 0, 0, “”) | |
| DC_0 | 1 | |
| TST_TYPE_0 | > | |
| TST_VAL_0 | 75 | |
| OPAND_0 | and | |
| PRECEDENCE_0 | | |
| DC_1 | 2 | |
| TST_TYPE_1 | > | |
| TST_VAL_1 | 75 | |
| OPAND_1 | | |
| PRECEDENCE_1 | | |
| . . . | | |

As such, in operation, after all data criteria has been entered for the data_components and the Generic Event-Reaction Definition Table, AM server periodically obtains results for the data_components and then populates the results into a processing engine for Generic Event-Reaction results.

In order to obtain results for the data_components, the E-R/G module converts the data into an equivalent SQL query which is submitted to database 306. The database returns the results which then can be provided to the Generic Event-Reaction Definition Table for processing therein.

It will be appreciated that reactions to events may also call a custom java module that is designed to manage specific information and states. This module may be initiated either on the server or by manipulating the control tables, to enable virtually any application on any such system to be run with any parameters in response to any situation.

It will be appreciated that communications between the control system and application agents are generally initiated by the application agent. In the embodiment, commands are not actively transmitted in messages from server 104. Instead, commands are set within values in known and predefined fields in database 306 in server 104. Application agents are set to periodically access database 108 and examine for any commands and then act accordingly. In other embodiments, the data from the database may be collected and selectively pushed to all appropriate clients, using messaging techniques known to those skilled in the art.

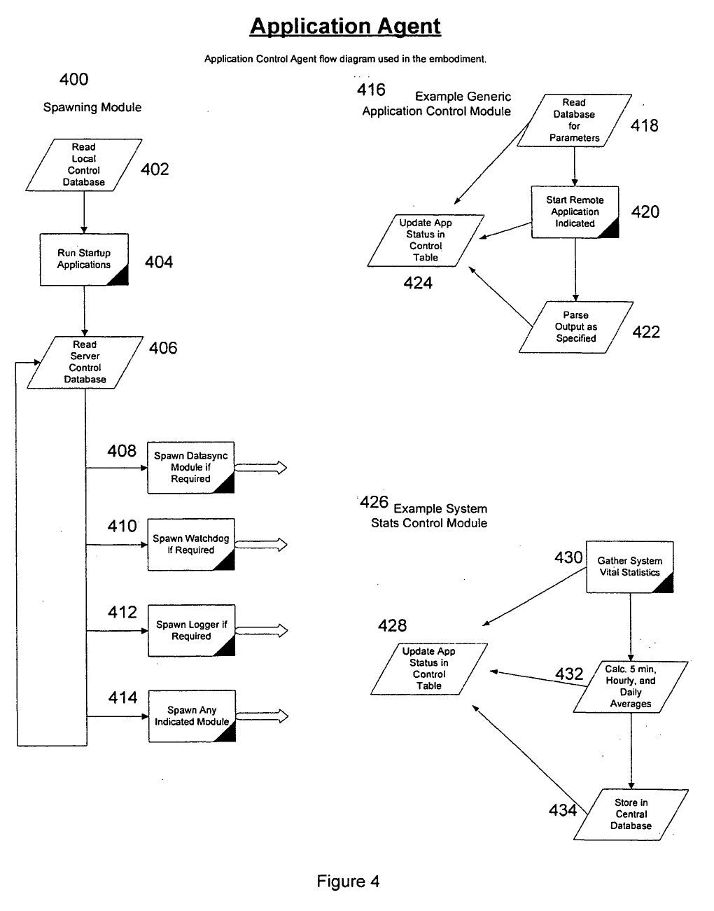

Referring to FIGS. 4, 5, 6 and 7 further detail is provided on selected algorithms operating on components in and on data structures used by the application agent 202 and AM server 104.

First, referring to FIG. 4, detail is provided on operation of application agent 202. In particular, for spawning module 212, flow chart 400 shows its main steps. At step 402, the module reads the local control database (if necessary) at the client. At step 404, any start-up application for the is activated. Then at step 406, the module continually reads the configuration file at AM server 104. After each read cycle, the spawning module 212 may selectively activate other modules in separate steps, including: activating data synchronization module 210 at step 408, activating monitor module 214 at step 410, activating logger module 222 at step 412 or activating any other module, as necessary, at step 414.

For generic module 224, flow chart 416 shows its main steps. First at step 420 the application is started. Then the status flag is set in the master control table indicating that the application has started. Then at step 422, the output is parsed and the exit status of the application is determined. At step 424 the final status flag in the master control table is set, indicating that the application has run and is finished.

For system stats module 220, flow chart 426 shows its main steps. First, at step 428, the application status in the master control table is set to “running”. Next, at step 430 relevant system statistics are gathered. Next at step 432, statistical analysis is done on the statistics (such as average calculations) and the results are stored at step 434. Finally, the status field of the application in the master control table is set to “finished running” in step 436.

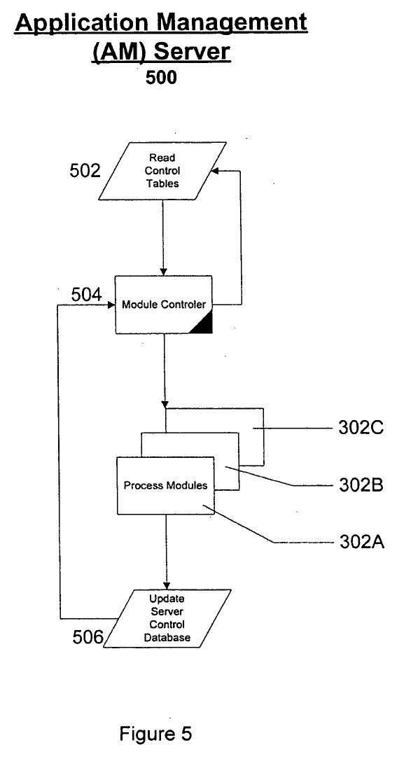

Next, referring to FIG. 5, further detail is provided on the operation of AM server 104. In particular, a flow chart of the operation of an overall operating process within the control system is shown generally at 500. As noted earlier, for a given application, the control system relies on central master control tables and possibly custom application specific tables with additional information supplied through the AM server and from information from other application agents. First, at step 502, the configuration data is read from the control tables in the configuration files. Next, at step 504, the module controller analyzes the configuration files and spawns any required module(s) 302 (described earlier) in reaction to the configuration files. The server control database is updated in step 506 and then the process returns to step 504.

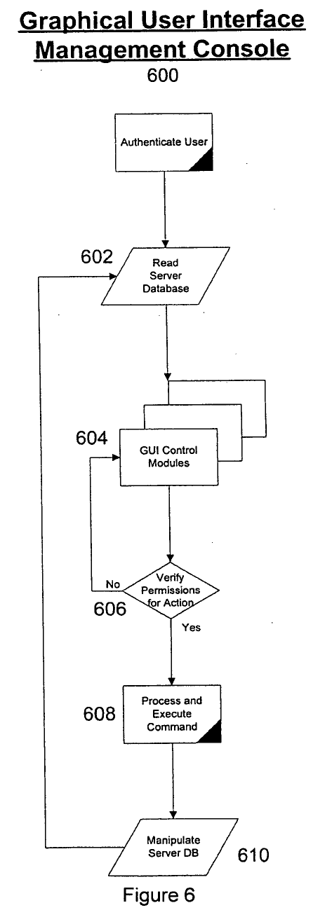

Next, referring to FIG. 6, a flow chart of the operation of an overall operating process within the GUI application 304 on AM server 104 is shown generally at 600. As noted earlier, the GUI application provides a user interface for the control system. At step 602, the output files 310 and configuration files 308 in database 306 are read. Then, using any relevant data, at step 604, any selected or initiated GUI control module may be initiated. Within the control module, the administrator is prompted for data or programming actions. GUI control modules include: a firewall tool, an IDS tool, a traffic optimization tool, a scanning tool, a report generator, an actions configurator and user and database maintenance tools. For any of the modules, once the user provides input, at step 606 a check is made to confirm that the user has any appropriate permission(s) implement any of his requested updates. If such permission(s) are confirmed, then at step 608, the command are executed and at step 610, any updates to the configuration files are made.

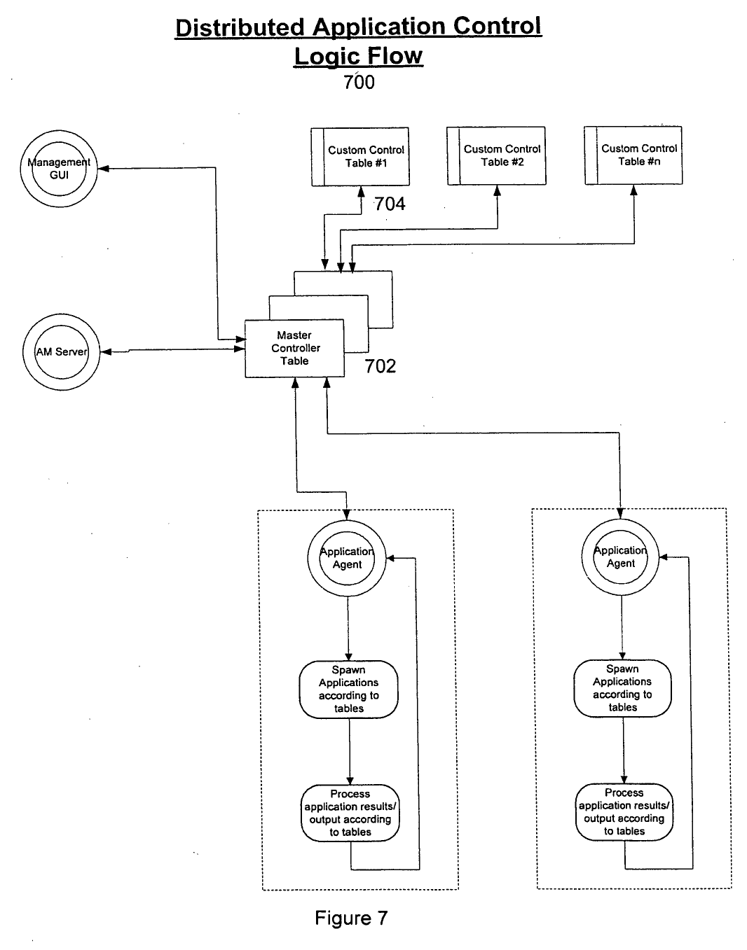

Next, referring to FIG. 7, further detail on database 306 is provided. The configuration files in database 306 comprise master control tables 700 which contain control data required by spawning module 212 in application agent 202 to operate its designated application. Generally a control table 700 contains data for most of the parameters for the designated application. However, in certain environments, custom tables 702 are used and are linked to control table 700. Size and content of custom tables 702 can be tailored to meet the requirements of the application. It will be appreciated that other tables having other fields may also be used.

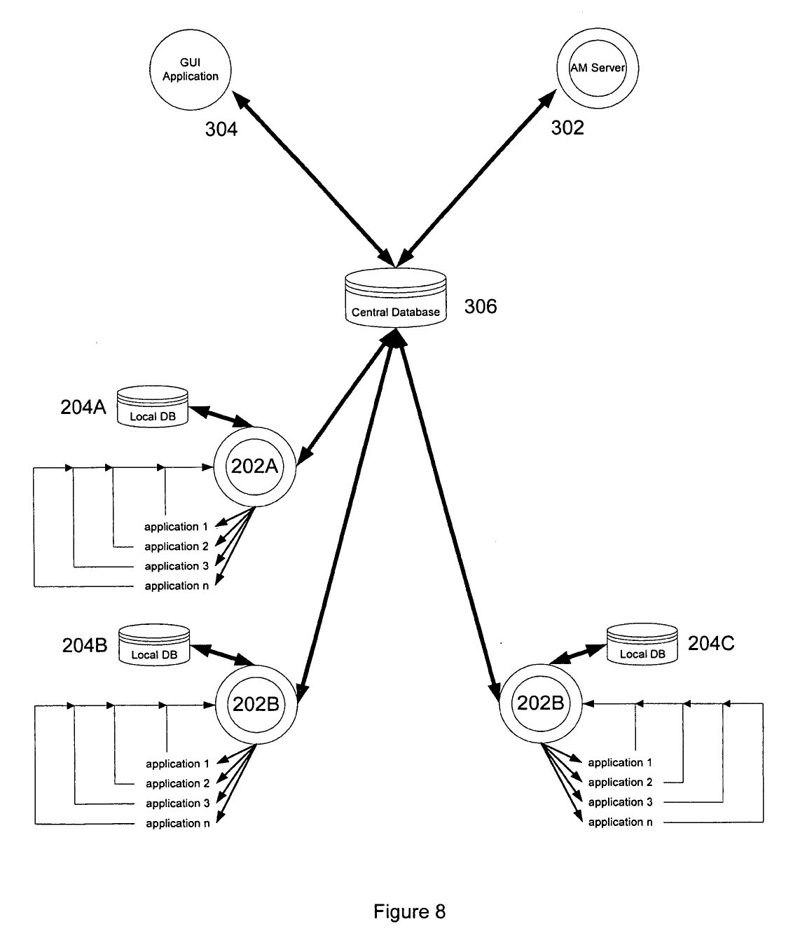

Finally, referring to FIG. 8, another view of the embodiment is provided showing application agents 202A, 202B and 202C distributed throughout a network on various clients being in communication with database 306 which is controlled, as described above, by AM server 302 and GUI module 304.

Although the invention has been described with reference to certain specific embodiments, various modifications thereof will be apparent to those skilled in the art without departing from the scope of the invention as outlined in the claims appended hereto.

We claim:

1. A system for controlling a plurality of applications at remote locations from a central server, said system comprising:
at one location of said remote locations,
a remote application agent for controlling each application of said plurality of applications installed at said one remote location;
a control system installed at said central server; and
configuration data accessible by said application agent and said control system for said each application, wherein
said application agent
periodically accesses said configuration data to determine operating parameters for said each application;
initiates activation of said each application according to said configuration data; receives output data from said each application; and
produces a filtered version of said output data and forwards said filtered version to said control system,
and
said control system
receives, reads and stores said filtered data; and
updates said configuration data to refine operation of said each application after analyzing said filtered data.

2. The system for controlling a plurality of applications at remote locations from a central server, as claimed in claim 1 wherein said configuration data is stored in a configuration file associated with said control system.

3. The system for controlling a plurality of applications at remote locations from a central server, as claimed in claim 2, further comprising
local configuration data for said each application stored at said remote location, said local configuration data containing initialization data for said each application.

4. The system for controlling a plurality of applications at remote locations from a central server, as claimed in claim 3, wherein
said control system updates said configuration data utilizing configuration data for another application of said plurality of applications.

5. The system for controlling a plurality of applications at remote locations from a central server, as claimed in claim 4, wherein said control system further provides an interface for an administrator to program update parameters for said configuration data based on said data of said another application.

6. The system for controlling a plurality of applications at remote locations from a central server, as claimed in claim 5, wherein
said local configuration data is periodically compared and reconciled with said configuration data associated with said control system.

7. The system for controlling a plurality of applications at remote locations from a central server, as claimed in claim 6, wherein said application agent further comprises a spawning module to control system calls for said application.

8. The system for controlling a plurality of applications at remote locations from a central server, as claimed in claim 7, wherein said application agent further comprises
a generic control module controlled by said spawning module, said generic control module executing commands having parameters which are stored with configuration data associated with said control system.

9. The system for controlling a plurality of applications at remote locations from a central server, as claimed in claim 8, wherein said each application relates to a security feature for said client.

10. The system for controlling a plurality of applications at remote locations from a central server, as claimed in claim 1, wherein said control system further
utilizes a set of conditions and a set of relationships linking elements in said set of conditions entered by a system administrator to trigger updating said configuration data to refine operation of said each application.

11. The system for controlling a plurality of applications at remote locations from a central server, as claimed in claim 10, wherein said control system further comprises
a reaction module to process data relating to said set of conditions and said set of relationships to selectively update said configuration data to refine operation of said each application.

12. A method for controlling a plurality of applications at remote locations from a central server, said method comprising:
at one location of said remote locations,
controlling each application of said plurality of applications installed at said one remote location through an application agent;
providing configuration data associated with said each application at a central location; and
providing a control system to manage updates to said configuration data in response to data provided from said application agent, wherein
said application agent
periodically accesses said configuration data to determine operating parameters for said each application;
initiates activation of said each application according to said configuration data;
receives output data from said each application; and
produces a filtered version of said output data and forwards said filtered version to said server application,
and
said control system
receives, reads and stores said filtered data; and
updates said configuration data to refine operation of said each application after analyzing said filtered data.

13. The method for controlling a plurality of applications at remote locations from a central server, as claimed in claim 12 wherein said configuration data is stored in a configuration file associated with said control system.

14. The method for controlling a plurality of applications at remote locations from a central server as claimed in claim 13, wherein local configuration data for said each application is stored at said remote location, said local configuration data containing initialization data for said each application.

15. The method for controlling a plurality of applications at remote locations from a central server as claimed in claim 14, wherein said control system updates said configuration data utilizing configuration data for another application of said plurality of applications.

16. The method for controlling a plurality of applications at remote locations from a central server as claimed in claim 15, wherein said control system further provides an interface for an administrator to program update parameters for said configuration data based on said data of said another application.

17. The method for controlling a plurality of applications at remote locations from a central server as claimed in claim 16, wherein said local configuration data is periodically compared and reconciled with said configuration data associated with said control system.

18. The method for controlling a plurality of applications at remote locations from a central server as claimed in claim 17, wherein said application agent further comprises a spawning module to control system calls for said application.

19. The method for controlling a plurality of applications at remote locations from a central server as claimed in claim 18, wherein said application agent further comprises a generic control module controlled by said spawning module to execute commands having parameters which are stored with configuration data associated with said control system.

20. The method for controlling a plurality of applications at remote locations from a central server as claimed in claim 18, wherein control system utilizes a set of conditions and a set of relationships linking elements in said set of conditions entered by a system administrator to trigger updating said configuration data to refine operation of said each application.
